(19) United States
(12) Patent Application Publication
(10) Pub. No.: US 2025/0272483 A1
(43) Pub. Date: Aug. 28, 2025

(54) H5 PAGE INTERACTION METHOD AND DEVICE, H5 PAGE EDITING METHOD AND DEVICE, AND COMPUTER-READABLE MEDIUM

(71) Applicant: BOE Technology Group Co., Ltd., Beijing (CN)

(72) Inventor: Jian XU, Beijing (CN)

(21) Appl. No.: 18/704,905

(22) PCT Filed: Jul. 5, 2023
(86) PCT No.: PCT/CN2023/105847

§ 371 Date: Apr. 25, 2024

(30) Foreign Application Priority Data
Jul. 29, 2022 (CN) 202210908129.7

(51) Int. Cl. G06F 40/186; G06F 40/143

(52) U.S. Cl. CPC G06F 40/186; G06F 40/143

(57) ABSTRACT

Provided in the present disclosure is a HyperText Markup Language 5 (H5) page interaction method. The method comprises: receiving a target interaction operation on a target element of an H5 page; and executing a corresponding target component behavior by means of a target component bound with the target interaction operation. Further provided in the present disclosure are an H5 page interaction device, an H5 page editing method and device, and a computer-readable medium.

### CROSS-REFERENCE TO RELATED APPLICATION

The present disclosure is a U.S. National Phase Entry of International Application No. PCT/CN2023/105847 having an international filing date of Jul. 5, 2023, which claims priority to Chinese Patent Application No. 202210908129.7, filed to the CNIPA on Jul. 29, 2022. The above-identified applications are incorporated herein by reference in their entireties.

### TECHNICAL FIELD

The present disclosure relates to the technical field of the Internet, in particular to a method and a device for H5 page interaction and editing, and a computer readable medium.

### BACKGROUND

An H5 (also known as HTML5 (fifth generation Internet hypertext markup language)) page is a page based on the HTML5 language, which is widely used for advertising, invitations and so on.

In some related technologies, an H5 page only has the function of static display, but does not implement an ability of dynamic interaction logic. For example, the H5 page cannot transmit data in a sheet to a server, cannot acquire the data of components in the page, and cannot control a change of contents illustrated in the page.

### SUMMARY

The present disclosure provides a method and a device for H5 page interaction and editing, and a computer readable medium.

In a first aspect, a method for H5 page interaction is provided in an embodiment of the present disclosure, which includes:
receiving a target interaction operation on a target element of an H5 page; and
executing, by a target component bound to the target interaction operation, a corresponding target component behavior.

In some embodiments, the target component behavior includes at least one of the following:
routing jump, instruction execution, request sending, and event triggering.

In some embodiments, the target component behavior includes event triggering. After the target component bound to the target interaction operation executes the corresponding target component behavior, the method for H5 page interaction further includes:
reporting, by the target component, a triggered event to an event bus.

In some embodiments, the method for H5 page interaction in an embodiment of the present disclosure further includes:
monitoring, by a response component, the event bus, and executing a response component behavior corresponding to a subscribed event when the subscribed event is monitored.

In some embodiments, the response component behavior includes a display behavior.

In some embodiments, executing, by the target component bound to the target interaction operation, the corresponding target component behavior includes:
loading a target behavior code corresponding to the target component behavior on the target component.

In a second aspect, a method for editing an H5 page is provided in an embodiment of the present disclosure, which includes:
receiving an interaction selection instruction and a behavior selection instruction for a target element of an H5 page; wherein the interaction selection instruction includes a target interaction operation, and the behavior selection instruction includes a target component behavior; and
binding a target component corresponding to a target component behavior to the target interaction operation.

In some embodiments, the target component behavior includes event triggering; the method for editing an H5 page in an embodiment of the present disclosure further includes:
building an event bus; wherein the event bus is used for receiving a triggered event, and the target component is used for monitoring the event bus.

In some embodiments, the method for editing an H5 page in an embodiment of the present disclosure further includes:
receiving an event response instruction for a response component; wherein the event response instruction includes an event and a response component behavior;
enabling a response component corresponding to the response component behavior to subscribe the event; wherein the response component is used for performing the response component behavior when the subscribed event is monitored.

In some embodiments, receiving the behavior selection instruction for the target element of the H5 page includes receiving a target behavior code corresponding to the target component behavior;
binding the target component corresponding to the target component behavior to the target interaction operation includes loading the target behavior code on the target component.

In some embodiments, receiving the interaction selection instruction and the behavior selection instruction for the target element of the H5 page includes:
receiving selection on a preset target interaction and a preset target component behavior.

In some embodiments, the method for editing an H5 page in an embodiment of the present disclosure further includes:
defining a dynamic parameter through a template expression.

In a third aspect, a device for H5 page interaction is provided in an embodiment of the present disclosure, which includes:
one or more processors;
a memory on which one or more computer programs are stored; and
one or more I/O interfaces, connected between the one or more processors and the memory and configured to implement information interaction between the one or more processors and the memory.

When one or more computer programs are executed by the one or more processors, any method for H5 page interaction in the embodiments of the present disclosure can be implemented.

In a fourth aspect, a device for editing an H5 page is provided in an embodiment of the present disclosure, which includes:
one or more processors;
a memory on which one or more computer programs are stored; and
one or more I/O interfaces, connected between the one or more processors and the memory and configured to implement information interaction between the one or more processors and the memory.

When one or more computer programs are executed by the one or more processors, any method for editing an H5 page in the embodiments of the present disclosure can be implemented.

In a fifth aspect, a computer readable medium is provided in an embodiment of the present disclosure, the computer readable medium has a computer program stored thereon, when the computer program is executed by a processor, any method for H5 page interaction in the embodiments of the present disclosure, or any method for editing an H5 page in the embodiments of the present disclosure is implemented.

### BRIEF DESCRIPTION OF DRAWINGS

Accompanying drawings are used to provide a further understanding of the present disclosure, and constitute a part of the specification. They are used together with detailed embodiments to explain the present disclosure, but do not constitute limitations on the present disclosure. The above and other features and advantages will become more apparent to those skilled in the art by describing detailed exemplary embodiments with reference to the accompanying drawings.

FIG. 1 is a flowchart of a method for H5 page interaction according to an embodiment of the present disclosure.

FIG. 2 is a flowchart of another method for H5 page interaction according to an embodiment of the present disclosure.

FIG. 3 is a flowchart of a method for editing an H5 page according to an embodiment of the present disclosure.

FIG. 4 is a flowchart of another method for editing an H5 page according to an embodiment of the present disclosure.

FIG. 5 is a logical schematic diagram of a process of editing an H5 page obtained according to an embodiment of the present disclosure.

FIG. 6 is a schematic diagram of a framework of an H5 page obtained according to an embodiment of the present disclosure.

FIG. 7 is a composition block diagram of a device for H5 page interaction according to an embodiment of the present disclosure.

FIG. 8 is a composition block diagram of a device for editing an H5 page according to an embodiment of the present disclosure.

FIG. 9 is a composition block diagram of a computer readable medium according to an embodiment of the present disclosure.

### DETAILED DESCRIPTION

In order to enable those skilled in the art to better understand the technical solution of the present disclosure, a method and a device for H5 page interaction and for editing an H5 page, and a computer readable medium according to the present disclosure will be described in detail below with reference to the accompanying drawings.

The present disclosure will be described more fully hereinafter with reference to the accompany drawings, but the illustrated embodiments may be embodied in different forms and should not be construed as being limited to the embodiments set forth in the present disclosure. On the contrary, these examples are provided for the purpose of making the present disclosure thorough and complete, and will enable those skilled in the art to fully understand the scope of the present disclosure.

The present disclosure may be described with reference to a plan view and/or a cross-sectional view by mean of an ideal schematic diagram of the present disclosure. Therefore, example illustrations may be modified according to manufacturing techniques and/or tolerances.

The embodiments of the present disclosure and the features in the embodiments can be combined with each other if there is no conflict.

Terms used in the present disclosure are only used to describe specific embodiments but are not intended to limit the present disclosure. As used in the present disclosure, the term “and/or” includes any and all combinations of one or more related enumerated items. As used in the present disclosure, the singular forms “a” and “the” are also intended to include a plural form, unless the context clearly indicates otherwise. As used in the present disclosure, the terms “including” and “made of” specify the presence of stated features, integers, steps, operations, elements and/or components, but do not exclude the presence or addition of one or more other features, integers, steps, operations, elements, components and/or groups thereof.

Unless otherwise limiting, all terms used in the present disclosure including technical and scientific terms have a same meaning as would normally be understood by those ordinary skilled in the art. It will also be understood that terms such as those defined in commonly used dictionaries should be construed as having meanings consistent with their meanings in a context in a related art and the present disclosure, but will not be construed as having idealized or over-formal meanings unless expressly so defined in the present disclosure.

The present disclosure is not limited to the embodiments shown in the drawings, but includes modifications of configurations formed based on manufacturing processes. Therefore, the regions illustrated in the drawings have schematic properties, and the shapes of the regions shown in the drawings illustrate the specific shapes of the regions of the elements, but are not intended to be limiting.

In a first aspect, a method for H5 page interaction is provided in an embodiment of the present disclosure.

The method in an embodiment of the present disclosure is executed by a device (such as a terminal) that loads an H5 (also known as an HTML5 (fifth generation Internet Hypertext Markup Language)) page, or can also be considered to be executed by an H5 page, and a user can achieve some functions by operating the H5 page displayed on the device, that is, to achieve interaction of the H5 page.

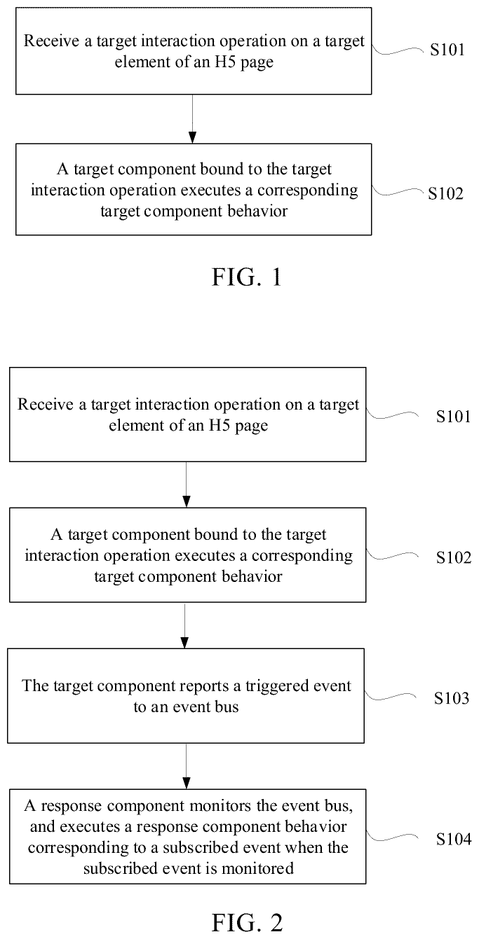

Referring to FIG. 1, a method for H5 page interaction in an embodiment of the present disclosure includes acts S101 to S102.

In S101, a target interaction operation on a target element of an H5 page is received.

When a user operates (such as clicks, double-clicks, drags, etc.), with a mouse or a touch screen, an element (such as an icon) in an H5 page displayed on a device, the H5 page (or the device) may receive the target interaction operation on the target element.

In S102, a target component bound to the target interaction operation executes a corresponding target component behavior.

The target interaction operation on the target element is bound with a certain target component behavior (such as entering a password) in advance. Therefore, after the H5 page receives the target interaction operation, the target component (such as a password component) corresponding to the target component behavior may execute the above-mentioned target component behavior (such as preparing to receive the password), thus achieving interaction of the H5 page.

It should be understood that the target component behavior may also have some related parameters, and the target component behavior may be specifically executed according to these parameters.

It should be understood that there may be a plurality of elements in the H5 page simultaneously, only some of the elements may be target elements (that is, interaction can be performed for only some elements). Or, all elements in the H5 page are target elements (that is, interaction can be performed for all the elements).

It should be understood that same target interaction operations for different target elements should be considered as different target interaction operations that can bind with different target component behaviors (e.g. clicking on an element A and clicking on an element B can cause different behaviors). Of course, it is also possible to bind with different target component behaviors for the same target interaction operation for different target elements (for example, both clicking on the element A and clicking on the element B can cause a same behavior).

It should be understood that each target interaction operation for each target element can have only one bound target component behavior (that is, each operation on the target element can cause only one behavior) or a plurality of bound target component behaviors (that is, each operation on the target element can cause a plurality of behaviors simultaneously).

It should be understood that, for each target element, there may be only one target interaction operation (that is, the target element may respond to only one operation) or a plurality of different target interaction operations (that is, the target element may respond to a plurality of different operations). Moreover, a plurality of different target interactions for each target element may bind with a same target component behavior (i.e. a plurality of different operations on the target element may cause a same behavior) or may bind with different target component behaviors (i.e. a plurality of different operations on the target element may cause different behaviors).

In an embodiment of the present disclosure, the target interaction operation for the target element is pre-bound with the target component behavior, so the target component can be triggered to execute the corresponding target component behavior by performing the target interaction operation on the target element. That is, the operation on the element of the H5 page can cause feedback from the H5 page, so that the interaction through the H5 page can be achieved.

In some embodiments, the target component behavior includes at least one of the following: routing jump, instruction execution, request sending, and event triggering.

As a mode of an embodiment of the present disclosure, a target component behavior, as an example, may include routing jump (that is, the H5 page jumps to another route), instruction execution (that is, the H5 page issues a specific control instruction to other external subjects, such as issuing an instruction to a terminal to require the terminal to perform operations such as vibration), request sending (that is, the H5 page sends an asynchronous request to a server, such as sending a search request to the server via the HTTP and obtaining corresponding result data), and event triggering (that is, the H5 page triggers a certain event, such as triggering an event for entering a password).

It should be understood that the target component behavior may be any behavior that any component of the H5 page can execute and is not limited to the specific examples above.

In some embodiments, referring to FIG. 2, the target component behavior includes event triggering. After the target component bound to the target interaction operation executes the corresponding target component behavior (S102), the method for H5 page interaction further includes an act S103.

In S103, the target component reports a triggered event to an event bus.

As a mode of an embodiment of the present disclosure, when the target component behavior includes event triggering, then after an event is trigged, the target component can also report the event to a preset event bus (i.e., an occurred event is reported to the bus), so that other components can know occurrence of the event through the event bus, and achieve mutual control and parameter transfer among the components in a global range, that is, achieve linkage among the components.

In some embodiments, referring to FIG. 2, the method for H5 page interaction in an embodiment of the present disclosure further includes an act S104.

In S104, a response component monitors the event bus, and when a subscribed event is monitored, a response component behavior corresponding to the subscribed event is executed.

As a mode of an embodiment of the present disclosure, some components (e.g., the response component) may need to respond after a certain event occurs, so the components can monitor data in the event bus, and execute the response component behavior corresponding to the subscribed event when monitoring that the event subscribed by themselves in advance has occurred, so as to achieve the linkage among the components.

It should be understood that the response component should continuously monitor the event bus and respond to any corresponding event monitored. Therefore, numbers and a description sequence of the above-mentioned acts S103 and S104 do not mean that the response component starts monitoring the event bus when the event has been reported to the event bus.

It should be understood that there may be a plurality of response components simultaneously monitoring the event bus and that the response components may subscribe to a same event or different events. That is, there may be a plurality of response components subscribing to an event (for example, one event can cause linkage of the plurality of response components), or there may be one response component subscribing to a plurality of events (for example, the plurality of events can cause linkage of the one response component).

It should be understood that it is also feasible if no response component exists.

In some embodiments, the response component behavior includes a display behavior.

As a mode of an embodiment of the present disclosure, the response component behavior that occurs when the response component responds to an event may be a display behavior that can affect a displayed content. For example, the display behavior may include, but is not limited to, displaying data, displaying a new content, hiding a content already displayed, changing a display style (e.g. highlighting, flashing, etc.), changing a display size (e.g. zooming, etc.).

It should be understood that the response component behavior may be any behavior that any component of the H5 page can execute and is not limited to the specific examples above.

In some embodiments, the target component bound to the target interaction operation executing the corresponding target component behavior (S102) includes an act S1021.

In S1021, the target behavior code corresponding to the target component behavior is loaded on the target component.

As a mode of an embodiment of the present disclosure, the user can also input a code (also known as a target behavior code) for an extended target component behavior (also known as an extended behavior) in advance, so that the H5 page can receive the target behavior code and load it on the target component to achieve correspondence between the target component and the target component behavior.

For example, the behavior to be extended can be written into a piece of code and recorded in a text file, so that the previously written code can be selected later to achieve logical loading.

In a second aspect, a method for editing an H5 page is provided in an embodiment of the present disclosure.

The method in an embodiment of the present disclosure is executed by a device that edits the H5 page, or may also be considered to be executed by an “H5 page editor (designer)”. Thus, a user can build a desired interactive H5 page by operating the device (in other words, using the “H5 page editor”).

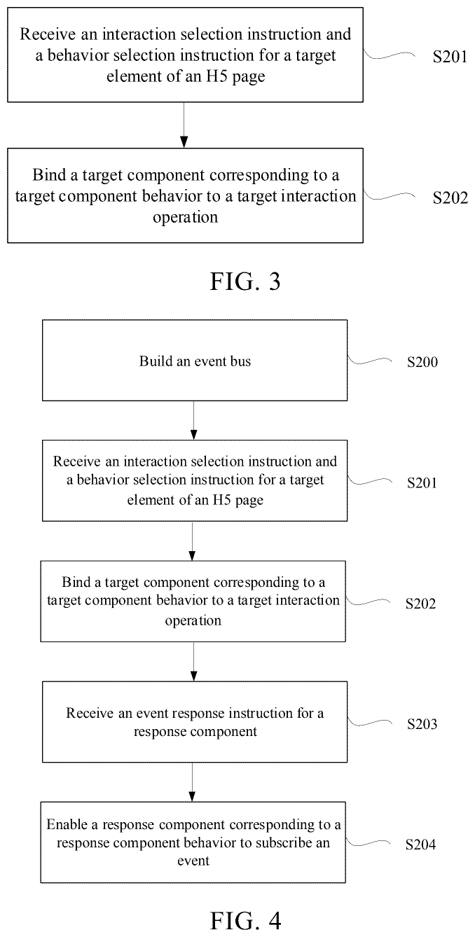

Referring to FIG. 3, the method for editing an H5 page in an embodiment of the present disclosure includes acts S201 to S202.

In S201, an interaction selection instruction and a behavior selection instruction for a target element of an H5 page are received.

The interaction selection instruction includes a target interaction operation, and the behavior selection instruction includes a target component behavior.

The user can operate the H5 page editor to select the target interaction operation and target component behavior for the target element in the H5 page, that is, to select the target component behavior that should be triggered when the target interaction operation is performed on the target element.

In S202, a target component corresponding to a target component behavior is bound to the target interaction operation.

Therefore, after receiving a user's selection instruction (the interaction selection instruction and the behavior selection instruction), the H5 page editor can bind the target interaction operation on the target element with the target component behavior according to the selection instruction, thereby causing the target component to execute the target component behavior when a subsequent user performs the target interaction operation on the target element of the H5 page.

It should be understood that there are various detailed modes by which the user gives the above-mentioned interaction selection instructions, behavior selection instructions and the like. For example, after the user selects the target element on the H5 page, a pop-up window can be given, so that the user can select the target interaction operation and the target component behavior related to the target element in a dropdown menu of the pop-up window. Or, the interaction selection instruction and the behavior selection instruction can be input by other means such as inputting codes.

It should be understood that the target component behavior needs some related parameters, and these related parameters can also be input in the behavior selection instruction.

It should be understood that the method for editing an H5 page in an embodiment of the present disclosure may further include an act of editing a display content, an element and the like of the H5 page. In other words, the H5 page editor may also have a function of editing the display content, the element and the like of the H5 page, which is not be described in detail herein.

In some embodiments, referring to FIG. 4, the target component behavior includes event triggering, and the method for editing an H5 page in an embodiment of the present disclosure further includes an act S200.

In S200, an event bus is built.

The event bus is used to receive a triggered event, and the component is used to monitor the bus.

As a mode of an embodiment of the present disclosure, if different components need to implement the linkage through events in the H5 page, the event bus can be built in advance. For example, the event bus may be built at first before editing other contents of the H5 page.

In some embodiments, referring to FIG. 4, the method for editing an H5 page in an embodiment of the present disclosure further includes acts S203 and S204.

In S203, an event response instruction for a response component is received.

The event response instruction includes an event and a response component behavior.

In S204, a response component corresponding to a response component behavior is enabled to subscribe an event.

The response component is used to perform the response component behavior when the subscribed event is monitored.

An H5 page editor receives user's selection (an event response instruction) on correlated events and response component behaviors, and the corresponding response component is enabled to subscribe a corresponding event according to the event response instruction, thereby achieving mutual control and parameter transfer among components, that is, achieving linkage of the components later.

In some embodiments, receiving the interaction selection instruction and the behavior selection instruction for the target element of the H5 page (S201) includes an act S2011.

In S2011, selection on a preset target interaction and a preset target component behavior is received.

As a mode of an embodiment of the present disclosure, a plurality of candidate interaction operations and component behaviors may be “preset” in the editor, so that when editing an H5 page, a corresponding target interaction and a target component behavior can be directly selected (e.g. through a dropdown menu) therefrom.

It should be understood that other operations (e.g., building a bus etc.) in an embodiment of the present disclosure may also be accomplished by selecting preset instructions in an editor (designer).

Therefore, according to an embodiment of the present disclosure, the H5 page with an interaction ability is made through a simple operation on the editor. Compared with a method for editing an H5 page by inputting codes in some related technologies, the mode of an embodiment of the present disclosure can significantly reduce workload and greatly reduce requirement on a professional level of users.

In some embodiments, receiving the behavior selection instruction for the target element of the H5 page (S201) includes an act S2012.

In S2012, a target behavior code corresponding to a target component behavior is received.

Binding the target component corresponding to the target component behavior to the target interaction operation (S202) includes an act S2021.

In S2021, the target behavior code is loaded on the target component.

As another mode of an embodiment of the present disclosure, in addition to selecting a preset target interaction operation to be correlated with the target component behavior, a target component behavior can be “customized”, that is, a target behavior code representing the target component behavior (extended behavior) to be performed is input and the target behavior code is loaded on the target component. Therefore, when the H5 page runs, the target behavior code can be dynamically compiled and mixed into the corresponding target behavior component, and loaded on the trigger mode of the target behavior component through an onListener monitor.

Therefore, the H5 page edited in an embodiment of the present disclosure has good expansibility, wherein, the component and the behavior execution can be arbitrarily combined, thereby achieving richer interaction contents and interaction logical behaviors.

In some embodiments, the method for editing an H5 page in an embodiment of the present disclosure further includes defining dynamic parameters through a template expression.

In an embodiment of the present disclosure, many parameters need to be defined, and these parameters can be dynamic parameters defined by template expressions, that is, the parameters can also be dynamic.

For example, the dynamic parameters are defined through the template expressions, so that the expressions can be used to obtain converted variables needed in the context when running, so as to obtain the needed dynamic parameters.

For example, as a detailed mode of an embodiment of the present disclosure, a procedure for editing and interacting with an H5 page in an embodiment of the present disclosure is described in detail below.

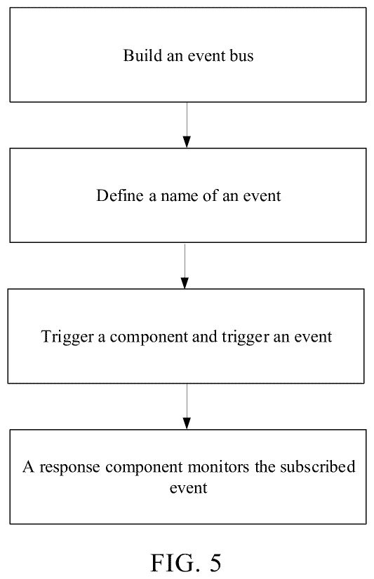

Referring to FIG. 5, a main process in an embodiment of the present disclosure may be as follows.

In A01, a global event bus is built to provide a basic linkage capability.

For example, a global event bus capability is provided through a front-end framework VUE.

The global event bus is started by default when the application is started, that is, Var EventBus=new Vue( ).

In A02, an interaction operation that triggers a component behavior is added to an element.

For example, an element (target element) in the H5 page editor may be selected.

After that, a new behavior is selected, specifically, selecting clicking, double clicking, or the like as an interaction operation (target interaction operation) that triggers the component behavior from a drop-down menu, and specifically selecting a preset component behavior (target component behavior) such as routing jump, instruction execution, request sending and event triggering.

For example, the component behavior may specifically be an event that triggers to reset a password (resetPassword).

At the same time, corresponding parameters of the component behavior may also be input. For example, when the component behavior is event triggering, a corresponding event name, an event parameter and the like can be input.

For example, a name of the above-mentioned event of resetting a password may be “user.resetPassword”.

After that, dynamic parameter binding is performed to bind the component to the selected component behavior (such as binding with the name of the component behavior), and parameter setting is performed.

For the preset component behavior, a parameter type and a content value may also be static and unchanged predetermined values, specifically, may include a data type, a quantity and a value of a parameter.

The parameters can also be dynamic. For example, the dynamic parameters are defined through the template expressions, so that the expressions can be used to obtain converted variables needed in the context when running, so as to obtain the needed dynamic parameters.

For example, if an H5 page context object is a page cache object (pageContext) and the parameter to be transferred is a user identity (userId), the template expression {{pageContext. userId}} can be used as the definition of that parameter.

Thus, during actual operating, the template expression can be compiled using a template string template as follow:
Const userId=_.template(‘{{pageContext.userId}}’, pageContext).

Thus, the actual userId parameter is dynamic and may change with the content in the pageContext context.

A user can also customize a component behavior, in other words, add an “extended behavior”.

For example, after selecting an element by a user, the user may also click to add a new behavior, input a name of the component behavior to be added, set a parameter configuration, and input and edit a corresponding behavior code (hereinafter referred to as a code block).

The code block may be stored dynamically. For example, a small code block may be automatically embedded in a global DSL, while a larger code block may be stored as a file on a server side.

Therefore, when the H5 page runs, the code block is dynamically compiled and mixed in the corresponding component, and the component loads the behavior corresponding to the code block on trigger of the component through the onListener monitor, and the loading of the extended behavior is completed.

For example, the extended behavior is a piece of javascript code logic, and a front-end programming framework has an ability to mix this piece of code logic in the execution function, so that the behavior can be customized.

Specifically, the behavior to be extended can be written into a piece of code and recorded in a text file, while the target element is specified when designing, so the code written previously can be selected later to achieve logical loading.

When the program runs, a program framework reads the code in the code file, performs string escaping, and forms a logical code that is mixed in a target element behavior handler, such that the extended behavior can be responded when the target interaction operation is performed on the target element.

In A03, an event subscribed by a response component is set, and a response component behavior is set.

For example, the response component may be set to monitor page data changes by default ($SetPageData), so that when data changes in any page, the response component makes a response and is triggered.

For example, data may be saved to the page cache object (pageContext) by using the vuex by default, so that the default data may be preset when setting the page, and various response component behaviors can be accomplished by monitoring data changes.

For example, the response component behavior may be displaying an expression, such as {{isShowElement}}, a result is compiled and calculated according to data cached in the page, so as to determine whether the component performs displaying or not.

For example, a value expression might look like {{page.element.Count}} and displays the calculated actual data result to the corresponding component.

For example, the response component may accomplish an event subscription using EventBus.$ on (‘user.resetPassword’, (params)=>{//do something}).

The response component can also bind with other response component behaviors, such as monitoring status data in real time, controlling its own display behavior, including controlling display data, whether to display, display style and so on.

A plurality of different response components can also all make a response, because the page cache object (pageContext) is shared by all components of the whole H5 page.

A plurality of components in the H5 page can subscribe to a same event, so that when the event is triggered, the plurality of components subscribing to the same event would respond to the event at the same time.

For example, there are two components in the H5 page, wherein a component 1 is used to display a status of a current device as ON or OFF, and a component 2 is used to display a name of the current device, and data binding with the two components are the current device (currentDevice).

Therefore, when the current device in pageContext.currentDevice changes from A to B, the two components may respond to the change of data at the same time, the device state of the component 1 may change, and the current device displayed by the component 2 may also change to B. That is, a plurality of components may automatically respond to the change of data and accomplish the logic bound with their own data.

The response component behavior can also be customized by users. For example, the user can input the event name to a component behavior panel, and tick a corresponding processing behavior to accomplish event response.

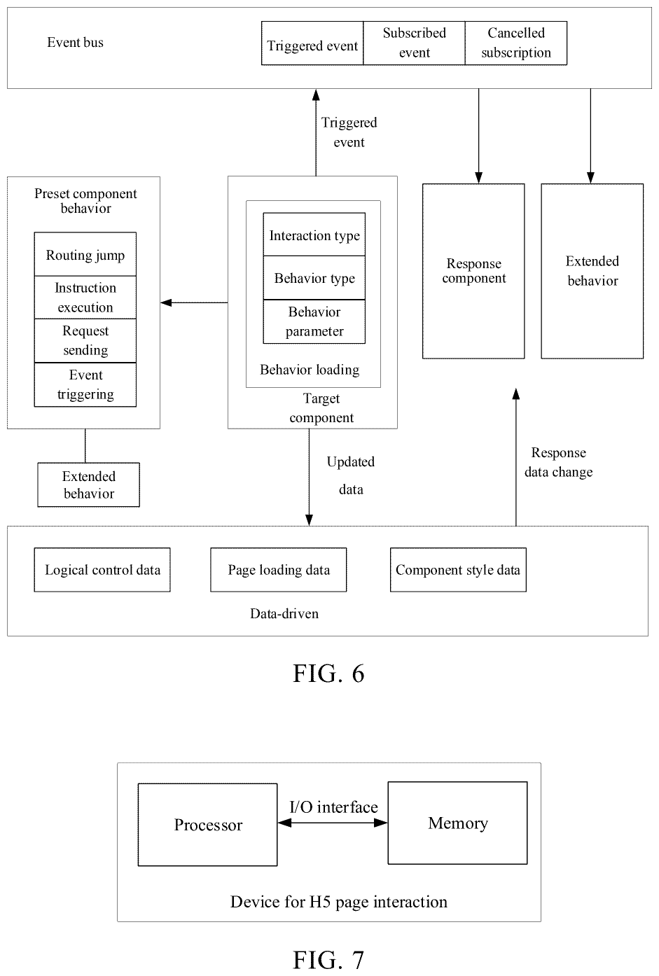

Referring to FIG. 6, in an H5 page edited with a method in an embodiment of the present disclosure, a time bus can transmit a triggered time, a subscription time, a cancelled subscription, etc.

A data-driving level can include logical control data, page loading data, component style data and other data, the data can be updated when the target component performs the target component behavior, and a change of data can be transmitted to each response component in response to the change of the data (boxes of a plurality of response components in FIG. 6 represent different response components).

In A04, during the H5 page operating, if the user executes a selected interaction operation such as clicking and double clicking on an element, a corresponding component can be triggered to execute a corresponding component behavior.

For example, when the user clicks a current element, trigger of a reset password event EventBus.$ emit (‘user.resetPassword’, {‘pwd’: ‘passsword’}) can be executed. A name of the event may be consistent with a name of the event that needs to be triggered. A first parameter of the response method is the event parameter, and a handler of the event determines a next interaction behavior of this component.

In A05, the response component monitors a change of data in the event bus, so as to make a response behavior in response to the event after the event is triggered.

For example, the response components may control display hiding, change a display size and style, and display data.

In a third aspect, referring to FIG. 7, a device for H5 page interaction is provided in an embodiment of the present disclosure, which includes:
one or more processors;
a memory on which one or more computer programs are stored:
one or more I/O interfaces, connected between the processor and the memory, configured to enable information interaction between the processor and the memory;
when one or more computer programs are executed by the one or more processors, any method for H5 page interaction in the embodiments of the present disclosure can be implemented.

In a fourth aspect, referring to FIG. 8, a device for editing an H5 page is provided in an embodiment of the present disclosure, which includes:
one or more processors;
a memory on which one or more computer programs are stored:
one or more I/O interfaces, connected between the processor and the memory, configured to enable information interaction between the processor and the memory;
when one or more computer programs are executed by the one or more processors, any method for editing an H5 page in the embodiments of the present disclosure can be implemented.

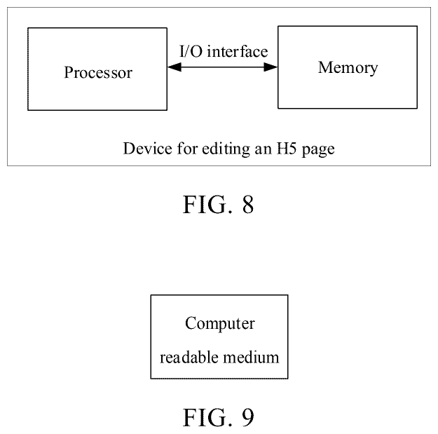

In a fifth aspect, referring to FIG. 9, a computer readable medium is provided in an embodiment of the present disclosure, the computer readable medium has a computer program stored thereon, when the computer program is executed by a processor, any method for H5 page interaction in the embodiments of the present disclosure, or any method for editing an H5 page in the embodiments of the present disclosure is implemented.

In an embodiment of the present disclosure, the processor is a device with data processing capability, including but not limited to a Central Processing Unit (CPU) and the like. The memory is a device having data storage capability, including but not limited to a Random Access Memory (RAM, more specifically a Synchronous Dynamic Random Access Memory (SDRAM), a Double Data Rate (DDR), etc.), a Read Only Memory (ROM), an Electrically Erasable Programmable Read Only Memory (EEPROM), a FLASH memory (FLASH). An Input/Output interface (I/O interface) is connected between the processor and the memory, includes, but is not limited to, an event bus and the like, and can achieve information interaction between the processor and the memory.

Those of ordinary skills in the art may understand that all or some of acts, systems, functional modules or units in apparatuses disclosed above may be implemented as software, firmware, hardware, and an appropriate combination thereof.

In a hardware implementation, division of the function modules/units mentioned in the above description is not always corresponding to division of physical components. For example, a physical component may have multiple functions, or a function or an act may be executed by several physical components in cooperation.

Some physical components or all physical components may be implemented as software executed by a processor such as a central processor (CPU), a digital signal processor or a microprocessor, or implemented as hardware, or implemented as an integrated circuit such as a specific integrated circuit. Such software may be distributed on a computer-readable medium, and the computer-readable medium may include a computer readable medium (or a non-transitory medium) and a communication medium (or a transitory medium). As known to those of ordinary skills in the art, a term, a computer readable medium, includes volatile and nonvolatile, removable and irremovable media implemented in any method or technology for storing information (for example, computer-readable instructions, a data structure, a program module, or other data). Computer readable media include, but are not limited to, Random Access Memory (RAM, more specifically SDRAM, DDR, etc.), Read Only Memory (ROM), Electrically Erasable Programmable Read-only Memory (EEPROM), flash memory (FLASH), or other disk memories; CD-ROM, Digital Versatile Disk (DVD) or other optical disk storage; Magnetic cassettes, magnetic tape, magnetic disk storage or other magnetic storage; any other media that can be used to store desired information and can be accessed by a computer. In addition, it is known to those of ordinary skills in the art that the communication medium usually includes computer-readable instructions, a data structure, a program module, or other data in a modulated data signal, such as, a carrier or other transmission mechanisms, and may include any information delivery medium.

Example embodiments have been disclosed in the present disclosure, and although specific terms are employed, they are only used and should only be interpreted in a general illustrative sense, and are not used for the purpose of limitation. In some examples, it is obvious to those skilled in the art that the features, characteristics and/or elements described in connection with specific embodiments may be used alone or in combination with those described in connection with other embodiments, unless explicitly stated otherwise. Therefore, it will be understood by those skilled in the art that various changes in form and details may be made without departing from the scope of the present disclosure as set forth in the appended claims.

1. A method for fifth generation Internet hypertext markup language H5 page interaction, comprising:
receiving a target interaction operation on a target element of an H5 page, wherein there are a plurality of elements in the H5 page simultaneously, some or all of the elements are target elements, when a user operates an element in an H5 page displayed on a device, the H5 page receives the target interaction operation on the target element; and
executing, by a target component bound to the target interaction operation, a corresponding target component behavior, wherein the target interaction operation on the target element is bound with a target component behavior in advance, and after the H5 page receives the target interaction operation, a target component corresponding to the target component behavior executes the target component behavior.

2. The method of claim 1, wherein the target component behavior comprises at least one of:
routing jump, instruction execution, request sending, and event triggering.

3. The method of claim 1, wherein the target component behavior comprises event triggering; after the target component bound to the target interaction operation executes the corresponding target component behavior, the method further comprises:
reporting, by the target component, a triggered event to an event bus.

4. The method of claim 3, further comprising:
monitoring, by a response component, the event bus, and executing a response component behavior corresponding to a subscribed event when the subscribed event is monitored.

5. The method of claim 4, wherein
the response component behavior comprises a display behavior, wherein the display behavior comprises at least one of following operations: displaying data, displaying a new content, hiding a content already displayed, changing a display style, and changing a display size.

6. The method of claim 1, wherein executing, by the target component bound to the target interaction operation, the corresponding target component behavior, comprises:
loading a target behavior code corresponding to the target component behavior on the target component.

7. A method for editing an H5 page, comprising:
receiving an interaction selection instruction and a behavior selection instruction for a target element of an H5 page; wherein there are a plurality of elements in the H5 page simultaneously, some or all of the elements are target elements, the interaction selection instruction comprises a target interaction operation, and the behavior selection instruction comprises a target component behavior, and when a user operates an H5 page editor, the user selects the target interaction operation and the target component behavior for the target element in the H5 page; and
binding a target component corresponding to the target component behavior to the target interaction operation, wherein, after receiving a user's selection instruction, the H5 page editor binds the target interaction operation on the target element with the target component behavior according to the selection instruction, to enable the target component to execute the target component behavior when a subsequent user performs the target interaction operation on the target element of the H5 page.

8. The method of claim 7, wherein the target component behavior comprises event triggering; and the method further comprises:
building an event bus; wherein the event bus is used for receiving a triggered event, and the target component is used for monitoring the event bus.

9. The method of claim 8, further comprising:
receiving an event response instruction for a response component; wherein the event response instruction comprises an event and a response component behavior;
enabling a response component corresponding to the response component behavior to subscribe the event; wherein the response component is used for performing the response component behavior when the subscribed event is monitored.

10. The method of claim 7, wherein
receiving the behavior selection instruction for the target element of the H5 page comprises receiving a target behavior code corresponding to the target component behavior;
binding the target component corresponding to the target component behavior to the target interaction operation comprises loading the target behavior code on the target component.

11. The method of claim 7, wherein receiving the interaction selection instruction and the behavior selection instruction for the target element of the H5 page comprises:
receiving selection on a preset target interaction and a preset target component behavior.

12. The method of claim 7, further comprising:
defining a dynamic parameter through a template expression.

13. A device for H5 page interaction, comprising:
one or more processors;
a memory on which one or more computer programs are stored; and
one or more I/O interfaces, connected between the one or more processors and the memory and configured to implement information interaction between the one or more processors and the memory,
wherein when the one or more computer programs are executed by the one or more processors, the method for H5 page interaction of claim 1 is capable of being implemented.

14. A device for editing an H5 page, comprising:
one or more processors;
a memory on which one or more computer programs are stored; and
one or more I/O interfaces, connected between the one or more processors and the memory and configured to implement information interaction between the one or more processors and the memory,
wherein when the one or more computer programs are executed by the one or more processors, the method for editing an H5 page of claim 7 is capable of being implemented.

15. A non-transient computer readable medium having a computer program stored thereon, wherein when the computer program is executed by a processor, the method for H5 page interaction of claim 1 is implemented.

16. A non-transient computer readable medium having a computer program stored thereon, wherein when the computer program is executed by a processor, the method for editing an H5 page of claim 7 is implemented.

17. A device for H5 page interaction, comprising:
one or more processors;
a memory on which one or more computer programs are stored; and
one or more I/O interfaces, connected between the one or more processors and the memory and configured to implement information interaction between the one or more processors and the memory,
wherein when the one or more computer programs are executed by the one or more processors, the method for H5 page interaction of claim 2 is capable of being implemented.

18. A device for H5 page interaction, comprising:
one or more processors;
a memory on which one or more computer programs are stored; and
one or more I/O interfaces, connected between the one or more processors and the memory and configured to implement information interaction between the one or more processors and the memory,
wherein when the one or more computer programs are executed by the one or more processors, the method for H5 page interaction of claim 3 is capable of being implemented.

19. A device for H5 page interaction, comprising:
one or more processors;
a memory on which one or more computer programs are stored; and
one or more I/O interfaces, connected between the one or more processors and the memory and configured to implement information interaction between the one or more processors and the memory,
wherein when the one or more computer programs are executed by the one or more processors, the method for H5 page interaction of claim 4 is capable of being implemented.

20. A device for H5 page interaction, comprising:
one or more processors;
a memory on which one or more computer programs are stored; and
one or more I/O interfaces, connected between the one or more processors and the memory and configured to implement information interaction between the one or more processors and the memory,
wherein when the one or more computer programs are executed by the one or more processors, the method for H5 page interaction of claim 5 is capable of being implemented.
